(19) United States
(12) Patent Application Publication
(10) Pub. No.: US 2018/0224850 A1
(43) Pub. Date: Aug. 9, 2018

(54) AUTONOMOUS VEHICLE CONTROL SYSTEM IMPLEMENTING TELEASSISTANCE

(71) Applicant: Uber Technologies, Inc., San Francisco, CA (US)

(72) Inventors: Benjamin Kroop, Pittsburgh, PA (US); Matthew Way, Pittsburgh, PA (US); Robert Sedgewick, Pittsburgh, PA (US)

(21) Appl. No.: 15/427,967

(22) Filed: Feb. 8, 2017

(51) Int. Cl. G05D 1/00

(52) U.S. Cl. CPC G05D 1/0088; G05D 1/0038

(57) ABSTRACT

An autonomous vehicle (AV) can dynamically analyze sensor data from a sensor suite to autonomously operate acceleration, braking, and steering systems along a current route. In analyzing the sensor data, the AV can determine a teleassist state requiring remote human assistance, and determine a plurality of decision options to resolve the teleassist state. The AV may then generate a teleassistance data package corresponding to the plurality of decision options, and transmit the teleassistance data package to a remote teleassistance system to enable a human operator to select one of the plurality of decision options for execution by the AV.

### BACKGROUND

The advancement of autonomous vehicle (AV) technology involves the safe transition from current programs requiring occasional on-board human intervention and awareness or full autonomy in test environments to enabling safe, fully-autonomous systems with capabilities equal to or greater than human drivers in virtually all driving scenarios. This transition towards “Level 5” autonomy entails the goal of removing human involvement entirely in the operation of the AV in typical and unexpected traffic scenarios on public roads and highways.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example autonomous vehicle operated by a control system implementing a teleassistance module, as described herein;

FIG. 2 is a block diagram illustrating an example teleassistance module utilized in connection with an autonomous vehicle, according to examples described herein;

FIG. 3 shows an example of an autonomous vehicle utilizing sensor data to navigate an environment in accordance with example implementations;

FIG. 4 shows an example autonomous vehicle initiating teleassistance, in accordance with example implementations;

FIG. 5 is a flow chart describing an example method of initiating teleassistance with a remote operator, according to examples described herein;

FIG. 6 is another flow chart describing an example method of initiating teleassistance with a remote operator, according to examples described herein;

FIG. 7 is a block diagram illustrating a computer system for an autonomous vehicle upon which examples described herein may be implemented; and

FIG. 8 is a block diagram illustrating a computer system for a backend datacenter upon which example transport systems described herein may be implemented.

### DETAILED DESCRIPTION

An autonomous vehicle (AV) can include a sensor suite to generate a live sensor view of a surrounding area of the AV and acceleration, braking, and steering systems autonomously operated by a control system. In various implementations, the control system can dynamically analyze the sensor view of the surrounding area and a road network map, or a highly detailed localization map, in order to autonomously operate the acceleration, braking, and steering systems along a current route to a destination.

The control system can further execute an instruction set that causes that control system to dynamically analyze the sensor view to operate the acceleration, braking, and steering systems along a current route. In analyzing the sensor data, the control system can determine a teleassist state or situation requiring remote human assistance. The control system can then determine a plurality of decision options to resolve the teleassist state, and generate a teleassistance data package corresponding to the plurality of decision options. The control system may then transmit the teleassistance data package to a remote teleassistance system to enable a human operator to select one of the plurality of decision options.

In various implementations, the teleassist state can correspond to at least one of an occlusion, a blockage in the current route, or an indeterminate object. In some aspects, each of the plurality of decision options can comprise a manner in which to address the teleassist state. Additionally or alternatively, the control system of the AV can determine the plurality of decision options using a combination of map data and the sensor data from the sensor suite. In certain examples, the teleassistance data package can comprise at least one of telemetry data, a route plan corresponding to the current route, and image data from the sensor suite. For example, the image data comprises a video stream from one or more selected cameras of the sensor suite.

According to certain implementations, the control system can receive a response message from the remote teleassistance system indicating a selected decision option, by the human teleassistance operator from the plurality of decision options, and can control the acceleration, braking, and steering systems of the AV to execute the selected decision option. In some aspects, the selected decision option can correspond to one of a wait command, an ignore command, a maneuver command, or an alternate route command. In certain variations, the teleassistance data package can include data enabling the human operator to patch into a telemetry stream of the AV and one or more video streams from the sensor suite of AV. Additionally, the one or more video streams can correspond to individual camera systems of the sensor suite, and the teleassistance data package can enable the human operator to selectively toggle through video data from each of the individual camera systems of the AV.

Among other benefits, the examples described herein achieve a technical effect of enabling the AV to initiate teleassistance with a remote human operator and provide a number of alternative options determined on-board. This technical effect results in increased autonomy on the AV to advance machine learning and significantly reduce instances of teleassistance requests.

As used herein, a computing device refers to devices corresponding to desktop computers, cellular devices or smartphones, personal digital assistants (PDAs), laptop computers, tablet devices, virtual reality (VR) and/or augmented reality (AR) devices, wearable computing devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, virtual reality (VR) or augmented reality (AR) computers, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as those carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

As provided herein, the term “autonomous vehicle” (AV) describes any vehicle operating in a state of autonomous control with respect to acceleration, steering, braking, auxiliary controls (e.g., lights and directional signaling), and the like. Different levels of autonomy may exist with respect to AVs. For example, some vehicles may enable autonomous control in limited scenarios, such as on highways. More advanced AVs, such as those described herein, can operate in a variety of traffic environments without any human assistance. Accordingly, an “AV control system” can process sensor data from the AV's sensor array, and modulate acceleration, steering, and braking inputs to safely drive the AV along a given route.

System Description

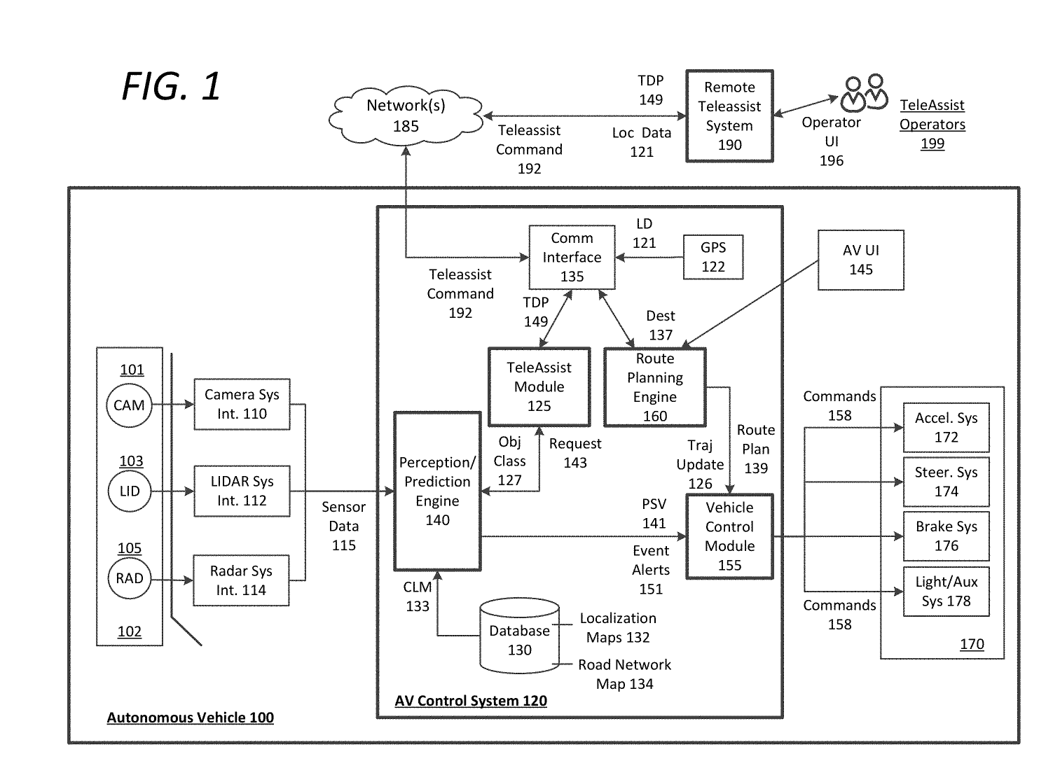

FIG. 1 is a block diagram illustrating an example AV operated by a control system implementing a teleassistance module, as described herein. In an example of FIG. 1, a control system 120 can autonomously operate the AV 100 in a given geographic region for a variety of purposes, including transport services (e.g., transport of humans, delivery services, etc.). In examples described, the AV 100 can operate without human control. For example, the AV 100 can autonomously steer, accelerate, shift, brake, and operate lighting components. Some variations also recognize that the AV 100 can switch between an autonomous mode, in which the AV control system 120 autonomously operates the AV 100, and a manual mode in which a driver takes over manual control of the acceleration system 172, steering system 174, braking system 176, and lighting and auxiliary systems 178 (e.g., directional signals and headlights).

According to some examples, the control system 120 can utilize specific sensor resources in order to autonomously operate the AV 100 in a variety of driving environments and conditions. For example, the control system 120 can operate the AV 100 by autonomously operating the steering, acceleration, and braking systems 172, 174, 176 of the AV 100 to a specified destination 137. The control system 120 can perform vehicle control actions (e.g., braking, steering, accelerating) and route planning using sensor information, as well as other inputs (e.g., transmissions from remote or local human operators, network communication from other vehicles, etc.).

In an example of FIG. 1, the control system 120 includes computational resources (e.g., processing cores and/or field programmable gate arrays (FPGAs)) which operate to process sensor data 115 received from a sensor system 102 of the AV 100 that provides a sensor view of a road segment upon which the AV 100 operates. The sensor data 115 can be used to determine actions which are to be performed by the AV 100 in order for the AV 100 to continue on a route to the destination 137. In some variations, the control system 120 can include other functionality, such as wireless communication capabilities using a communication interface 135, to send and/or receive wireless communications over one or more networks 185 with one or more remote sources. In controlling the AV 100, the control system 120 can generate commands 158 to control the various control mechanisms 170 of the AV 100, including the vehicle's acceleration system 172, steering system 157, braking system 176, and auxiliary systems 178 (e.g., lights and directional signals).

The AV 100 can be equipped with multiple types of sensors 102 which can combine to provide a computerized perception, or sensor view, of the space and the physical environment surrounding the AV 100. Likewise, the control system 120 can operate within the AV 100 to receive sensor data 115 from the sensor suite 102 and to control the various control mechanisms 170 in order to autonomously operate the AV 100. For example, the control system 120 can analyze the sensor data 115 to generate low level commands 158 executable by the acceleration system 172, steering system 157, and braking system 176 of the AV 100. Execution of the commands 158 by the control mechanisms 170 can result in throttle inputs, braking inputs, and steering inputs that collectively cause the AV 100 to operate along sequential road segments to a particular destination 137.

In more detail, the sensor suite 102 operates to collectively obtain a sensor view for the AV 100 (e.g., in a forward operational direction, or providing a 360 degree sensor view), and to further obtain situational information proximate to the AV 100, including any potential hazards or obstacles. By way of example, the sensors 102 can include multiple sets of camera systems 101 (video cameras, stereoscopic cameras or depth perception cameras, long range monocular cameras), LIDAR systems 103, one or more radar systems 105, and various other sensor resources such as sonar, proximity sensors, infrared sensors, and the like. According to examples provided herein, the sensors 102 can be arranged or grouped in a sensor system or array (e.g., in a sensor pod mounted to the roof of the AV 100) comprising any number of LIDAR, radar, monocular camera, stereoscopic camera, sonar, infrared, or other active or passive sensor systems.

Each of the sensors 102 can communicate with the control system 120 utilizing a corresponding sensor interface 110, 112, 114. Each of the sensor interfaces 110, 112, 114 can include, for example, hardware and/or other logical components which are coupled or otherwise provided with the respective sensor. For example, the sensors 102 can include a video camera and/or stereoscopic camera system 101 which continually generates image data of the physical environment of the AV 100. The camera system 101 can provide the image data for the control system 120 via a camera system interface 110. Likewise, the LIDAR system 103 can provide LIDAR data to the control system 120 via a LIDAR system interface 112. Furthermore, as provided herein, radar data from the radar system 105 of the AV 100 can be provided to the control system 120 via a radar system interface 114. In some examples, the sensor interfaces 110, 112, 114 can include dedicated processing resources, such as provided with field programmable gate arrays (FPGAs) which can, for example, receive and/or preprocess raw image data from the camera sensor.

In general, the sensor systems 102 collectively provide sensor data 115 to a perception/prediction engine 140 of the control system 120. The perception/prediction engine 140 can access a database 130 comprising stored localization maps 132 of the given region in which the AV 100 operates. The localization maps 132 can comprise highly detailed ground truth data of each road segment of the given region. For example, the localization maps 132 can comprise prerecorded data (e.g., sensor data including image data, LIDAR data, and the like) by specialized mapping vehicles or other AVs with recording sensors and equipment, and can be processed to pinpoint various objects of interest (e.g., traffic signals, road signs, and other static objects). As the AV 100 travels along a given route, the perception/prediction engine 140 can access a current localization map 133 of a current road segment to compare the details of the current localization map 133 with the sensor data 115 in order to detect and classify any objects of interest, such as moving vehicles, pedestrians, bicyclists, and the like.

In various examples, the perception/prediction engine 140 can dynamically compare the live sensor data 115 from the AV's sensor systems 102 to the current localization map 133 as the AV 100 travels through a corresponding road segment. The perception/prediction engine 140 can flag or otherwise identify any objects of interest in the live sensor data 115 that can indicate a potential hazard. In accordance with many examples, the perception/prediction engine 140 can output a processed sensor view 141 indicating such objects of interest to a vehicle control module 155 of the AV 100. In further examples, the perception/prediction engine 140 can predict a path of each object of interest and determine whether the AV control system 120 should respond or react accordingly. For example, the perception/prediction engine 140 can dynamically calculate a collision probability for each object of interest, and generate event alerts 151 if the collision probability exceeds a certain threshold. As described herein, such event alerts 151 can be processed by the vehicle control module 155 that generates control commands 158 executable by the various control mechanisms 170 of the AV 100, such as the AV's acceleration, steering, and braking systems 172, 174, 176.

On a higher level, the AV control system 120 can include a route planning engine 160 that provides the vehicle control module 155 with a route plan 139 and a travel trajectory 126 along a current route 139 to a destination 137. The current route 139 may be determined by a backend transport system, or may be determined by the AV 100 via access to a local or external mapping service. In some aspects, the AV 100 can include a user interface 145, such as a touch-screen panel or speech recognition features, which can enable a passenger to input a destination 137. Additionally or alternatively, the AV control system 120 can include a communication interface 135 providing the AV 100 with connectivity to one or more networks 185. In such implementations, the AV 100 may communicate with an on-demand transport system that manages routing of any number of AVs operating throughout a given region to provide transportation services to requesting riders. Thus, the route planning engine 160 may receive the destination 137 from the on-demand transport system over the network(s) 185 in order to plan a current route 139 for the AV 100.

In mapping the current route 139, the route planning engine 160 can generally utilize an on-board mapping engine or an external mapping service by transmitting map calls over the network(s) 185 in order to determine a most optimal route plan 139 from a current location of the AV 100 to the destination 137. This route plan 139 may be determined based on distance, time, traffic conditions, additional pick-ups (e.g., for carpooling services), and the like. For each successive road segment on which the AV 100 travels, the route planning engine 160 can provide trajectory data to the vehicle control module 155 to enable the vehicle control module 155 to operate the AV 100 safely to the next road segment or the destination 137. For example, the trajectory data can indicate that the vehicle control module 155 must change lanes or make a turn within the current localization map 133 in order to proceed to the next road segment along the current route plan 139.

According to examples provided herein, the vehicle control module 155 can utilize the route plan 139, the processed sensor view 141, and event alerts 151 to autonomously operate the control mechanisms 170 of the AV 100. As a basic example, to make a simple turn based on the route plan 139, the vehicle control module 155 can generate control commands 158 that cause the lights and auxiliary systems 178 of the AV 100 to activate the appropriate directional signal, the braking system 176 to slow the AV 100 down for the turn, the steering system 174 to steer the AV 100 into the turn, and the acceleration system 172 to propel the AV 100 when exiting the turn. In further examples, event alerts 151 may indicate potential hazards such as a pedestrian crossing the road, a nearby bicyclist, obstacles on the road, a construction area, proximate vehicles, an upcoming traffic signal and signal state, and the like. The vehicle control module 155 can respond to each event alert 151 on a lower level while, on a higher level, operating the AV 100 along the determined route plan 139 using the processed sensor view 141.

According to examples described herein, the control system 120 can include a teleassistance module 125 to enable remote human teleassistance operators 199 to aid the AV 100 in progressing along the route plan 139 when a teleassistance state or scenario is detected, or when the AV control system 120 encounters a “stuck” situation. As provided herein, the teleassistance state can comprise a detection anomaly in which the control system 120 has difficulty detecting objects (e.g., due to an occlusion), an identification or classification anomaly in which the perception/prediction engine 140 has difficulty classifying detected objects, a scenario in which the AV control system 120 is unable to make a safe decision (e.g., a crowded pedestrian area), or a fault condition corresponding to a diagnostics fault or failure of a component of the AV 100, such as a computer, a mechanical component, or a sensor. In normal operation, a teleassistance state can cause the AV 100 to slow down, pull over, or stop while the AV control system 120 attempts to resolve the teleassistance state.

In various implementations, when a teleassistance state exists, the perception/prediction engine 140 can submit a teleassistance request 143 to the teleassistance module 125. The teleassistance module 125 can treat the request 143 based on the type of teleassistance state to, for example, compile sensor data 115, prioritize certain types of sensor data 115, encode the sensor data 115 at different rates or qualities, specify an anomalous object in the sensor data 115 (e.g., using a bounding box), and/or incorporating telemetry, diagnostic data, and/or localization data (e.g., position and orientation of the AV 100) with the inquiry 143.

According to examples provided herein, based on the nature of the teleassistance state, the teleassistance module 125 can analyze the sensor data 115, the current route plan 139, a stored road network map 134 for the given region, and/or remotely accessible, live traffic data in order to determine a number of possible decision options for resolving the teleassistance state. In some examples, the teleassistance module 125 can determine the decision options based on a set of cost criteria, such as risk and time. In doing so, the teleassistance module 125 can compute the cost criteria for each of the potential options to determine whether to include the decision option in the set of decision options to be transmitted to remote teleassistance system 190. For example, in order to be included in the set of decision options, the AV teleassistance module 125 may require that each decision option have a risk cost below a certain risk threshold, and/or have a time cost below a certain time threshold.

Accordingly, the teleassistance module 125 can determine the set of decision options available based on a cost assessment filter and compile or generate the set of decision options as a teleassistance data package 149. The teleassistance data package 149 can include telemetry data (e.g., velocity, direction of travel, orientation, etc.) and specific sensor data 115 indicating each of the decision options. In some aspects, the teleassistance data package 149 can further include data enabling remote access to on-board sensor systems, such as individual camera or stereo-camera streams from the AV's 100 sensor suite 102. Accordingly, the teleassist module 125 of the AV control system 120 can initiate the connection with the remote teleassist system 190, and provide the teleassistance data package 149, which can enable a teleassistance operator 199 to patch into or access the selected sensor data 115 or video streams from the AV's 100 sensor suite 102.

Examples described herein recognize that network security for AVs 100 has been, and will be, an enduring concern in which certain procedures provide advantages to prevent unauthorized access from hackers or unscrupulous actors. According to examples described herein, the teleassistance module 125 can initiate the connection with the remote teleassistance system 190 to transmit the teleassistance data package 149. In some aspects, the teleassistance module 125 can establish a unidirectional secure connection to transmit the teleassistance data package 149 to the remote teleassistance system 190. Additionally or in variations, the teleassistance module 125 can securely access the remote teleassistance system 190 through virtual private network protocols, such as tunneling or certain encryption techniques in order to transmit the teleassistance data package 149, and provide remote access to the AV's 100 sensor data streams.

In various examples, the AV control system 120 can further include a location-based resource, such as a GPS module 122 to provide location data 121 to the remote teleassistance system 190. In various examples, the teleassistance data package 149 and the location data 121 can cause the teleassistance system 190 to generate an operator user interface 196 feature that enables a teleassistance operator 199 to quickly analyze each of the decision options supplied by the AV 100 and make a subjective selection of a most optimal decision option. As described in further detail herein, the operator user interface 196 can enable the teleassistance operator 199 to view relevant sensor data, location data 121, and telemetry data in the teleassistance data package 149 to analyze the teleassistance state of the AV 100.

In selecting a teleassistance operator 190, the teleassistance system 190 can determine a first available operator 199 and provide the operator user interface 196 to that operator 199. In certain implementations, the operator user interface 196 can enable the teleassistance operator 199 to toggle through individual video streams, via the teleassistance data package 149, from individual cameras or groups of cameras on the AV's 100 sensor suite 102 in order to provide more context to the teleassistance state. In addition, the operator user interface 196 can provide a live connection to the AV control system 120 of the AV 100 to enable the teleassistance operator 199 to receive contextual information concerning the teleassistance state, and make a quick decision regarding the set of decision options in the teleassistance data package 149.

Once the teleassistance operator 199 has selected a decision option on the operator user interface 196, the teleassistance system 190 can generate a teleassistance command 192 corresponding to the selected decision option, and provide the teleassistance command 192 to the AV 100. For example, the teleassistance system 190 can provide the teleassistance module 125 with access to the teleassistance command 192 over the network 185, or can actively transmit the teleassistance command 192 to the communication interface 135 of the AV 100. As described herein, the teleassistance command 192 can comprise a response message including an instruction to perform the selected decision by the teleassistance operator 199. It is to be noted that the selected decision was determined by the AV 100 itself and grouped into a plurality of decision options in the teleassistance data package 149. However, examples provided herein leverage the (current) significant advantages of human cognition to make the final decision. Such a system can provide vast amounts of decision data that can be used to “train” the AV control systems 120 (e.g., through software updates or deep learning techniques) of all AVs operating throughout a given region.

The teleassistance module 125 can process the teleassistance command 192 and generate a response to the source of the teleassistance state, depending on the cause of the teleassistance state. For example, if the perception/prediction engine 140 is unable to classify a detected object, the response message including the teleassistance command 192 can correspond to the classification of the indeterminate object 127. Thus, the teleassistance module 125 can provide the object classification 127 of the indeterminate object to the perception/prediction engine 140, which can complete the processed sensor view 141 (e.g., with the newly classified object 127) for the vehicle control module 155—or otherwise provide an event alert 151 if the classified object 127 comprises a hazard.

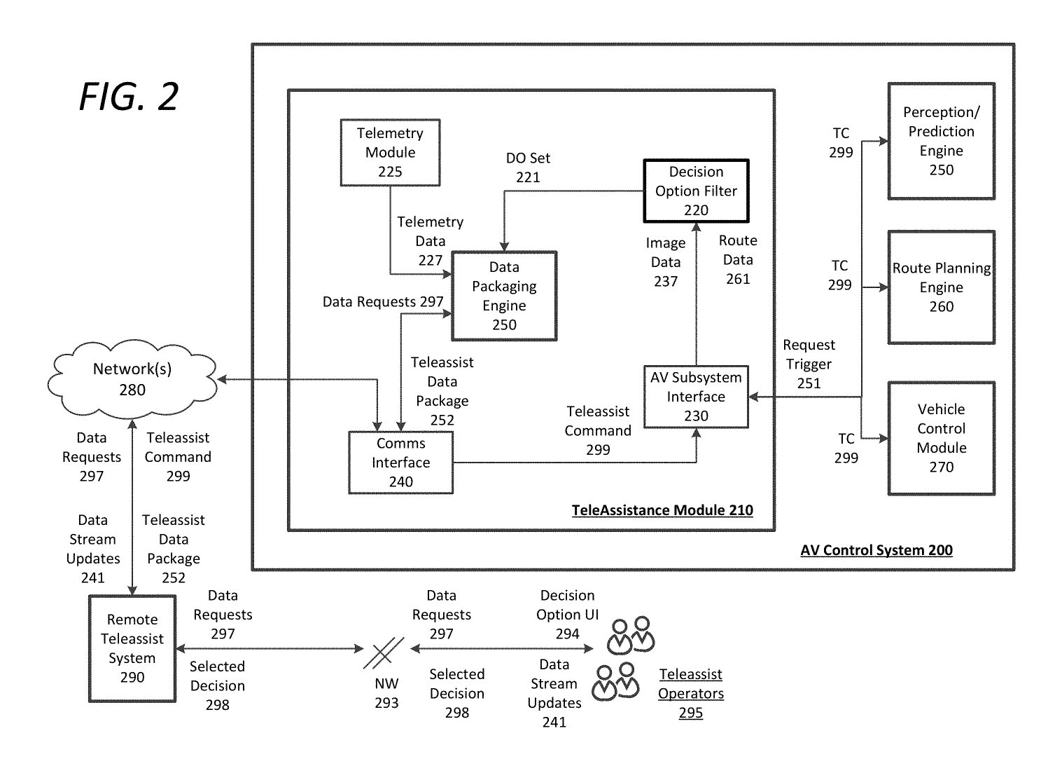

In variations, the teleassistance command 192 can comprise a maneuver command (e.g., maneuvering around a construction zone with caution), an ignore command, a wait command (e.g., in traffic accident scenarios), a command to proceed slowly with high caution, or an alternative route. Such commands can collectively comprise trajectory updates 126, which can be provided to the vehicle control module 155 for execution. Such trajectory updates 126 can correspond directly to the selected decision option by the human teleassistance operator 199 from a set of decision options generated by the teleassistance module 125 of the AV 100. Accordingly, the vehicle control module 155 can execute the trajectory update 126 by generating control commands 158 executable to modulate braking, steering, and acceleration inputs, and selectively initiating the lights and auxiliary systems 178 (e.g., signaling intent to other vehicles). Further description of the functions of the teleassistance module 125 is provided below with respect to FIG. 2.

FIG. 2 is a block diagram illustrating an example teleassistance module utilized in connection with an autonomous vehicle, according to examples described herein. The AV control system 200 of FIG. 2 can correspond to the AV control system 120 of FIG. 1. Furthermore, the teleassistance module 210, perception/prediction engine 250, route planning engine 260, and vehicle control module 270 of FIG. 2 can correspond to the teleassistance module 125, perception/prediction engine 140, route planning engine 160, and vehicle control module 155 shown and described with respect to FIG. 1. Referring to FIG. 2, any of the perception/prediction engine 250, the route planning engine 260, and the vehicle control module 270 can initiate a request trigger 251 to cause the teleassistance module 210 to generate a teleassistance data package 252 for remote teleassistance. The request trigger 251 can correspond to a teleassistance state in which the AV control system 200 is unable to resolve a certain anomaly, such as an indeterminate object, an occlusion in the sensor view, a closed road, a construction zone, a complex scenario (e.g., high pedestrian density, complex intersections, crowded bike lanes, etc.), and the like.

For example, the perception/prediction engine 250 can initiate a teleassist request trigger 251 when a sensor malfunctions or becomes misaligned, when there is a critical occlusion in the sensor view, or when it is unable to classify a detected object (e.g., a plastic bag in the AV's path). As another example, the route planning engine 260 can initiate a teleassist trigger 251 when the current route is blocked or the AV experiences a traffic jam. For example, the current route may include a blockage such as a construction zone, a closed road, a traffic incident or traffic jam, and the like. As yet another example, the vehicle control module 270 can initiate a teleassist request trigger when the vehicle diagnostics indicate an issue with the acceleration, braking, steering, shifting, or auxiliary systems (e.g., a low or flat tire, low oil pressure, low fuel or battery energy, overheating, etc.).

According to examples described herein, the teleassistance module 210 can include an AV subsystem interface 230 connecting the teleassistance module 210 with each of the perception/prediction engine 250, the route planning engine 260, and the vehicle control module 270. Based on the request trigger 251, the AV subsystem interface 230 can selectively provide image data 237 and/or route data 261 from the AV's sensor systems and/or route planning engine 260 to a decision option filter 220. The decision option filter 220 can utilize the image data 237 and/or route data 261 to determine a plurality of decision options in light of the request trigger 251. In other words, the request trigger 251 can indicate the nature of the teleassistance state of the control system 200, which the decision option filter 220 can process in order to generate a decision option set 221 that includes a number of optimal actions that the AV control system 200 can perform to overcome the teleassistance state.

In determining each of the decision options in the set 221, the decision option filter 220 can establish a set of criteria to filter out ineffective, burdensome, or costly options. For example, the decision option filter 220 can eliminate any options that have a time cost above a certain time threshold (e.g., five minutes) and/or a risk cost above a risk threshold. In doing so, the decision option filter 220 can analyze a road network map to identify any alternative routes, live traffic data to determine the increased ETA to the current destination, and the sensor data or processed sensor view to determine an immediate feasibility of each decision option (e.g., for low level maneuvers and U-turns). For indeterminate objects, the decision option filter 220 can also provide selected image data, from one or more specified cameras with the indeterminate object in the field of view, with the decision option set 221. In further aspects, the decision option filter 220 can also provide diagnostics data of the AV as general information for the human teleassistance operator 295.

The decision option filter 220 can transmit the decision option set 221 to a data packing engine 250 of the teleassistance module 210. In certain implementations, the teleassistance module 210 can also include a telemetry module 225 that can provide telemetry data 227 comprising the current orientation, location, velocity, and/or trajectory of the AV. The data packing engine 250 can compile the relevant sensor data (e.g., image data, LIDAR data, video streams, etc.) for each decision option in the set 221, the telemetry data 227, and in some aspects, diagnostics data into a teleassistance request package 252 for transmission to the remote teleassistance system 290. Accordingly, the teleassistance module 210 can include a communications interface 240 (e.g., the communications interface 135 shown in FIG. 1) that enables the teleassistance module 210 to initiate a secure connection with the remote teleassistance system 290 over one or more networks 280.

Upon receiving the teleassistance data package 252, the remote teleassistance system 290 can identify an available operator 295 and generate a decision option user interface 294 for display on a teleassistance operator's 295 computing device (e.g., a personal computer) to enable the remote operator 295 to select from one of the plurality of decision options in the set 221. In various implementations, the remote teleassistance system 290 can transmit the decision option user interface 294 to the available human teleassistance operator 295 over a local or wide area network 293. The decision option user interface 294 can include each of the decision options in the set 221 determined by the decision option filter 220 of the teleassistance module 210.

In certain aspects, the decision option user interface 294 enables the teleassistance operator 295 to selectively patch into the telemetry stream and/or sensor data stream from the AV control system 200 (e.g., using a personal computer or mobile computing device). For example, the teleassistance operator 295 may select certain request features on the decision option user interface 294 that cause a data request 297 to be generated and transmitted to the teleassistance module 210 via the remote teleassist system 290 and network(s) 280, 293. The data requests 297 can be processed by the data packaging engine 250 to provide the selected data stream update 241 back to the teleassistance operator 295 via the decision option user interface 294. This enables the human teleassistance operator 295 to selectively review the image data 237 or video streams from individual cameras on the AV to generate more context regarding the teleassistance state.

Upon reviewing the decision option set 221 in the decision option user interface 294, the teleassistance operator 295 can select a specified decision option 298 (e.g., via a user input or click input on the decision option user interface 294). Data indicating the selected decision 298 may then be transmitted from the human teleassistance operator's 295 computing device to the remote teleassistance system 290. Based on the selected decision 298, the remote teleassistance system 290 can generate a teleassistance command 299 instructing the AV control system 200 to execute the selected decision option 298. The remote teleassistance system 290 can transmit the teleassistance command 299 back to the teleassistance module 210 via the network(s) 280 and the communications interface 240. Upon receiving the teleassistance command 299, the communications interface 240 can relay or otherwise transmit the teleassistance command 299 to the AV subsystem interface 230, which can provide the teleassistance command 299 to the relevant AV subsystem (e.g., the perception/prediction engine 250, the route planning engine 260, or the vehicle control module 270) based on the nature of the teleassistance state.

Example teleassistance modules 210 in communication with a remote teleassistance system 290 can be distributed amongst any number of AVs operating throughout a given region (e.g., a metropolitan area managed by one or more datacenters, or a national level encompassing the whole of the United States). Accordingly, such a teleassistance mechanism can continue to leverage human cognition without the need of human assistance within the vehicle, and can contribute significantly to the transition into “Level 5” autonomy. It is contemplated that with continued progress in providing remote human teleassistance to AVs in predicted scenarios and in real-time will promote robustness in AV control systems, facilitating effectiveness in software updates and/or neural network learning.

Autonomous Vehicle in Operation

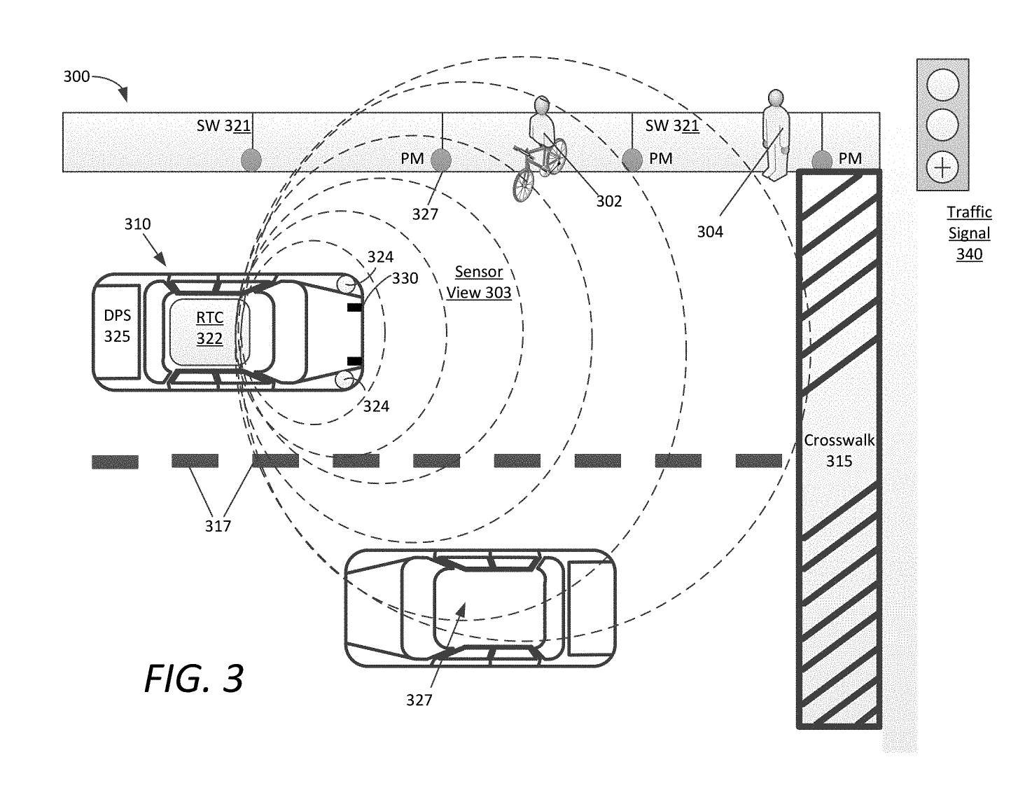

FIG. 3 shows an example of an AV utilizing sensor data to navigate an environment in accordance with example implementations. In an example of FIG. 3, the autonomous vehicle 310 may include various sensors, such as a roof-top camera array (RTC) 322, forward-facing cameras 324 and laser rangefinders 330. In some aspects, a data processing system 325, comprising a computer stack that includes a combination of one or more processors, FPGAs, and/or memory units, can be positioned in the cargo space of the vehicle 310.

According to an example, the vehicle 310 uses one or more sensor views 303 (e.g., a stereoscopic or 3D image of the environment 300) to scan a road segment on which the vehicle 310 traverses. The vehicle 310 can process image data or sensor data, corresponding to the sensor views 303 from one or more sensors in order to detect objects that are, or may potentially be, in the path of the vehicle 310. In an example shown, the detected objects include a bicyclist 302, a pedestrian 304, and another vehicle 327—each of which may potentially cross into a road segment along which the vehicle 310 traverses. The vehicle 310 can use information about the road segment and/or image data from the sensor views 303 to determine that the road segment includes a divider 317 and an opposite lane, as well as a sidewalk (SW) 321, and sidewalk structures such as parking meters (PM) 327.

The vehicle 310 may determine the location, size, and/or distance of objects in the environment 300 based on the sensor view 303. For example, the sensor views 303 may be 3D sensor images that combine sensor data from the roof-top camera array 322, front-facing cameras 324, and/or laser rangefinders 330. Accordingly, the vehicle 310 may accurately detect the presence of objects in the environment 300, allowing the vehicle 310 to safely navigate the route while avoiding collisions with other objects.

According to examples, the vehicle 310 may determine a probability that one or more objects in the environment 300 will interfere or collide with the vehicle 310 along the vehicle's current path or route. In some aspects, the vehicle 310 may selectively perform an avoidance action based on the probability of collision. The avoidance actions may include velocity adjustments, lane aversion, roadway aversion (e.g., change lanes or drive further from the curb), light or horn actions, and other actions. In some aspects, the avoidance action may run counter to certain driving conventions and/or rules (e.g., allowing the vehicle 310 to drive across center line to create space for bicyclist).

The AV 310 can further detect certain road features that can increase the vehicle's alertness, such as a crosswalk 315 and a traffic signal 340. In the example shown in FIG. 3, the AV 310 can identify certain factors that can cause the vehicle 310 to enter a high alert state, such as the pedestrian 304 being proximate to the crosswalk 315 or the bicyclist 302 being on the road. Furthermore, the AV 310 can identify the signal state of the traffic signal 340 (e.g., green) to determine acceleration and/or braking inputs as the AV 310 approaches the intersection. At any given time, the AV 310 can detect an anomaly—such as an indeterminate object or an issue with a sensor—and query a backend teleassistance system to resolve the anomaly.

According to examples described herein, the AV 310 may request remote teleassistance when, for example, the AV finds difficulty in proceeding safely. In the example shown in FIG. 3, the AV 310 may identify the orientation of the bicyclist 302, slow down, and request real-time teleassistance. In doing so, the AV 310 can generate a set of decision options to enable a remote, human operator to select from. A selected decision from the generated set may then be executed by the AV 310 in proceeding. In the example of FIG. 3, the AV 310 may generate a set of decision options that include stopping and waiting until the bicyclist passes, ignoring the bicyclist, slowing and proceeding with caution, sounding the horn, or any combination of the foregoing. In response, the human teleassistance operator may select “slow and proceed with caution,” allowing the AV 310 to proceed accordingly and with and added layer of confidence.

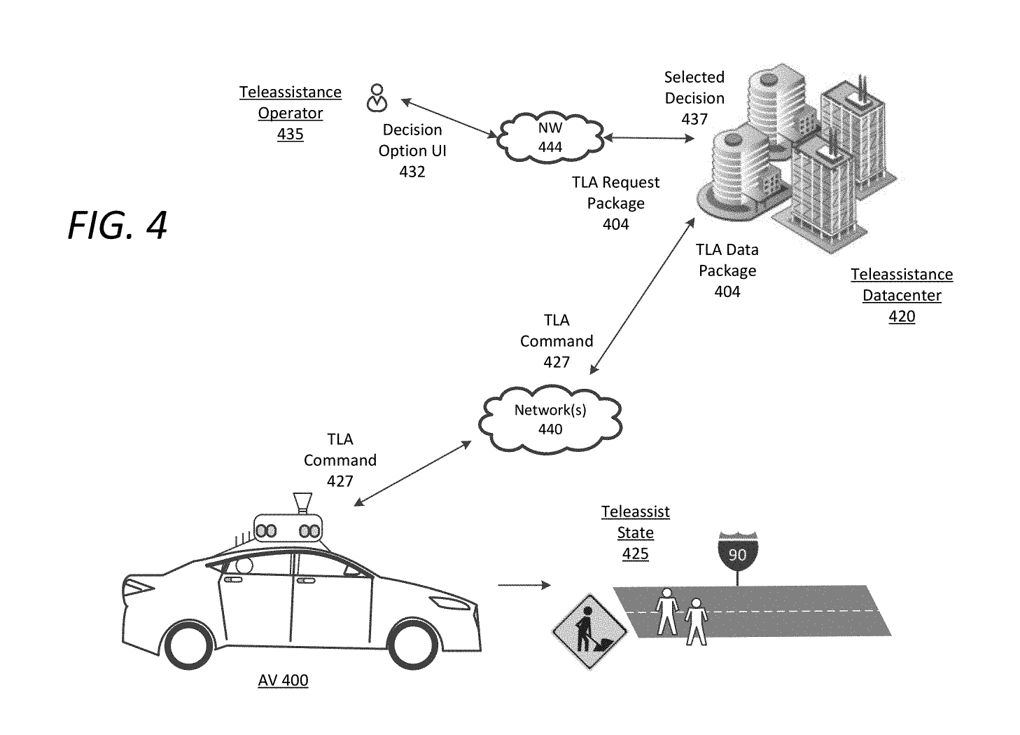

FIG. 4 shows an example autonomous vehicle initiating teleassistance, in accordance with example implementations. In the example shown in FIG. 4, an AV 400 approaches a location or scenario that causes a teleassist state 425 on the AV 400. In general, the teleassist state 425 can cause the AV 400 to slow down or stop due to safety, uncertainty (e.g., below a threshold), a set of criteria not being met to proceed (e.g., collision probability being exceeded, object uncertainty, or an anomalous situation, such as a road construction zone or pedestrians on the road, as shown). Based on the teleassistance state 425, the AV 400 can generate and transmit a teleassistance data package 404 over one or more networks 440 to a remote teleassistance datacenter 420 implementing a teleassistance system described herein. As further described herein, the teleassistance data package 404 can include a plurality of decision options determined by the AV 400, such as maneuvering around the pedestrians, turning the AV 400 around or following an alternate route, sounding the horn, proceeding slowly with asserted caution, and the like.

The teleassistance datacenter 420 can generate a decision option user interface 432 based on the teleassistance data package 404, which can include each of the decision options identified by the AV 400. As provided herein, the teleassistance datacenter 420 can connect with teleassistance operators over a local or non-local network 444. The teleassistance datacenter 420 can provide each of the decision options on a generated user interface 432 to an available human teleassistance operator 435. As described herein, the operator 435 can review the decision option user interface 432 and subjectively select what the operator 435 believes to be the most optimal option on the user interface 432. Data indicating the selected decision 437 may be transmitted back to the teleassistance datacenter 420, enabling the teleassistance datacenter 420 to generate a teleassistance command 427 corresponding to the selected decision 437. The teleassistance datacenter 420 may then transmit the teleassistance command 427 back to the AV 400 over the network(s) 440. the AV 400 may then execute the teleassistance command 427 to overcome or resolve the teleassistance state 425.

Methodology

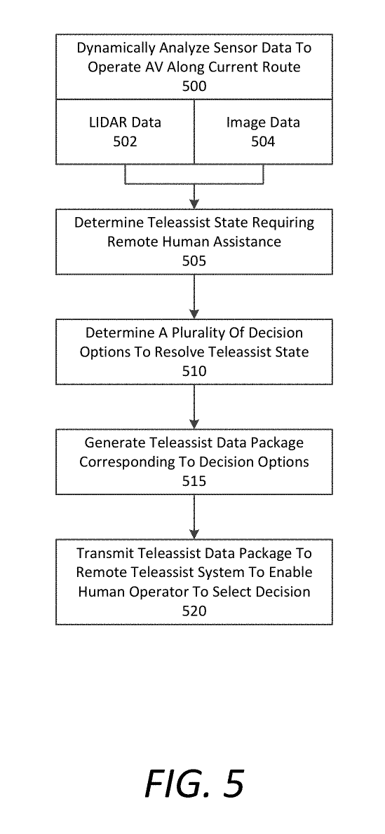

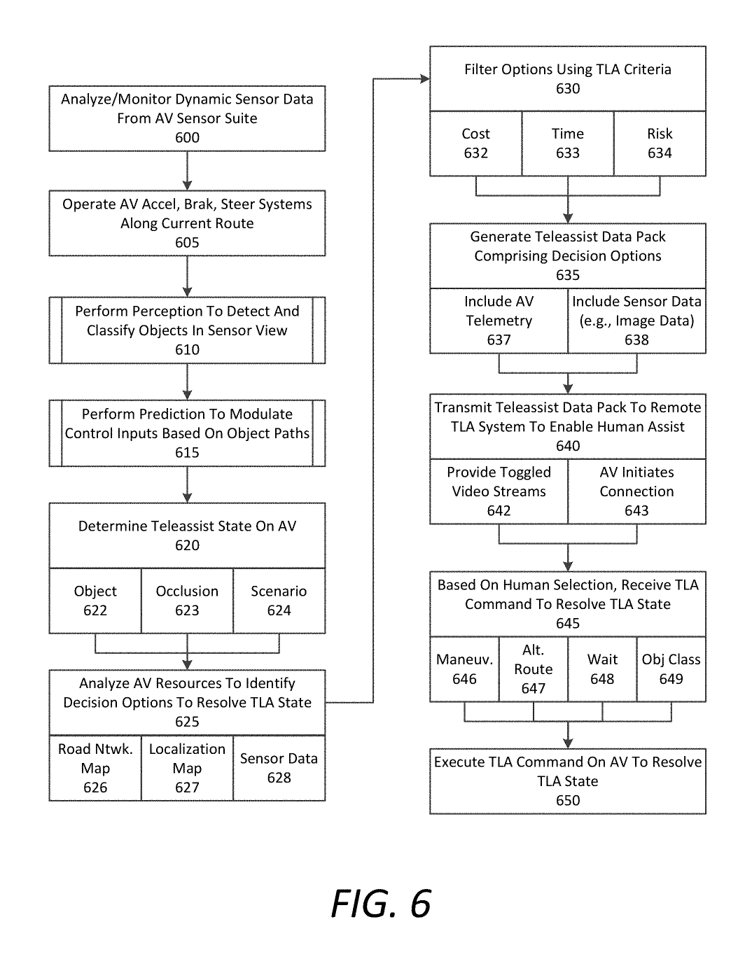

FIGS. 5 and 6 are flow charts describing example methods of initiating teleassistance with a remote operator, according to examples described herein. In the below descriptions of FIGS. 5 and 6, reference may be made to reference characters representing like features shown and described with respect to FIGS. 1 and 2. Furthermore, the steps and processes described with respect to FIGS. 5 and 6 below may be performed by an example autonomous vehicle (AV) 100 or AV control system 120, 200, as described herein with respect to FIGS. 1 and 2. Referring to FIG. 5, the AV control system 120 can dynamically analyze sensor data 115 to operate the AV 100 along a current route 139 (500). In doing so, the AV control system 120 can process real-time LIDAR data (502) and/or image data (504) to perform object detection and prediction operations.

In various examples, the AV control system 120 can determine a teleassistance state requiring remote human assistance, as described herein (505). Based on the teleassistance state, the AV control system 120 can determine a plurality of decision options to resolve or overcome the teleassistance state (510). The AV control system 120 may then generate a teleassistance data package 149 comprising the plurality of decision options (515). The AV control system 120 may then transmit the teleassistance data package 149 to the remote teleassistance system 190 to enable a human operator 199 to select a decision from the set of decision options identified by the AV control system 120 (520).

FIG. 6 is a lower level flow chart describing an example method of initiating remote teleassistance by an AV. Referring to FIG. 6, the AV control system 120 can analyze and/or monitor dynamic sensor data 115 from the sensor suite 102 of the AV 100 (600). Based on the sensor data 115, the AV control system 120 can operate the AV's 100 acceleration 172, braking, 176, and steering systems 174 along a current route 139 (605). In doing so, the AV control system 120 can perform perception operations to detect and classify objects of interest in the sensor view, such as pedestrians, bicyclists, other vehicles, and the like (610). Additionally, the AV control system 120 can perform prediction operations for each of the objects of interest to modulate control inputs on the various control mechanisms 170 of the AV 100 (615).

In various examples, the AV control system 120 can determine or otherwise identify a teleassistance state on the AV 100 (620) As described throughout, the teleassistance state can correspond to an indeterminate object (622), and occlusion in the sensor view (e.g., a misalignment, debris, a large truck, foliage, etc.) (623), or any number of scenarios described herein (624). The AV control system 120 may then analyze various AV resources to identify decision options to resolve or overcome the teleassistance state (625). Such AV resources can include a road network map 134 to identify any number of alternative routes (626), the current localization map 133 (627), and/or the sensor data 115 from the AV's sensor suite 102 (628).

In many examples, the AV control system 120 can filter the decision options using a set of teleassistance criteria, or otherwise rank the options (630). For example, the AV control system 120 can assess an overall cost for each of the decision options (632), which can include a time cost (633), and a risk cost (634). In some aspects, the AV control system 120 can limit the number of decision options to a predetermine number (e.g., the top three options). The AV control system 120 may then generate a teleassistance data package 149 comprising the decision options (635). In some aspects, the teleassistance data package 149 can also include telemetry data 227 of the AV 100 (637), and can further include select sensor data 115 relevant to the teleassistance state (638).

The AV control system 120 may then transmit the teleassistance data package 149 to the remote teleassistance system 190 to enable human assistance (640). In some examples, the teleassistance data package 149 can provide toggled video streams that enable a human teleassistance operator 199 to toggle through each camera or group of cameras (642). As described herein, the AV control system 120 can initiate the connection to transmit the teleassistance data package 149 (e.g., establishing a unidirectional connection, a virtual private network, encrypted communications, etc.) (643). Thereafter, the human teleassistance operator 199 can select one of the decision options, and data indicating the selection can be processed by the remote teleassistance system 190.

Based on the selection by the human operator 199, the AV control system 120 can receive a teleassistance command 192 to resolve or overcome the teleassistance state (645). As described, the teleassistance command 192 can correspond directly to one of the decision options identified or determined by the AV 100. The teleassistance command 192 can thus instruct the AV control system 120 to perform a maneuver (646), take an alternative route (647), wait or ignore the teleassistance state (648), and/or classify an indeterminate object for perception and prediction operations (649). The AV control system 120 may then execute the teleassistance command 192 and resolve or overcome the teleassistance state (650).

Hardware Diagrams

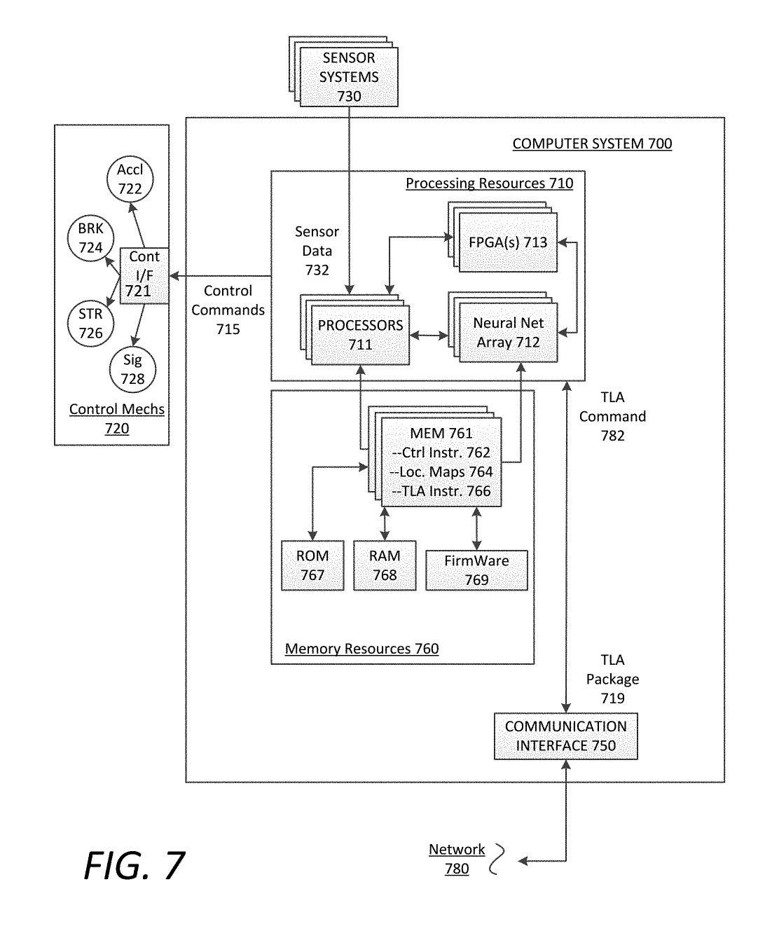

FIG. 7 is a block diagram illustrating a computer system upon which example AV processing systems described herein may be implemented. The computer system 700 can be implemented using a number of processing resources 710, which can comprise processors 711, field programmable gate arrays (FPGAs) 713. In some aspects, any number of processors 711 and/or FPGAs 713 of the computer system 700 can be utilized as components of a neural network array 712 implementing a machine learning model and utilizing road network maps stored in memory 761 of the computer system 700. In the context of FIGS. 1 and 2, various aspects and components of the AV control system 120, 200, can be implemented using one or more components of the computer system 700 shown in FIG. 7.

According to some examples, the computer system 700 may be implemented within an autonomous vehicle (AV) with software and hardware resources such as described with examples of FIGS. 1 and 2. In an example shown, the computer system 700 can be distributed spatially into various regions of the AV, with various aspects integrated with other components of the AV itself. For example, the processing resources 710 and/or memory resources 760 can be provided in a cargo space of the AV. The various processing resources 710 of the computer system 700 can also execute control instructions 762 using microprocessors 711, FPGAs 713, a neural network array 712, or any combination of the same.

In an example of FIG. 7, the computer system 700 can include a communication interface 750 that can enable communications over a network 780. In one implementation, the communication interface 750 can also provide a data bus or other local links to electro-mechanical interfaces of the vehicle, such as wireless or wired links to and from control mechanisms 720 (e.g., via a control interface 721), sensor systems 730, and can further provide a network link to a backend transport management system or a remote teleassistance system (implemented on one or more datacenters) over one or more networks 780.

The memory resources 760 can include, for example, main memory 761, a read-only memory (ROM) 767, storage device, and cache resources. The main memory 761 of memory resources 760 can include random access memory (RAM) 768 or other dynamic storage device, for storing information and instructions which are executable by the processing resources 710 of the computer system 700. The processing resources 710 can execute instructions for processing information stored with the main memory 761 of the memory resources 760. The main memory 761 can also store temporary variables or other intermediate information which can be used during execution of instructions by the processing resources 710. The memory resources 760 can also include ROM 767 or other static storage device for storing static information and instructions for the processing resources 710. The memory resources 760 can also include other forms of memory devices and components, such as a magnetic disk or optical disk, for purpose of storing information and instructions for use by the processing resources 710. The computer system 700 can further be implemented using any combination of volatile and/or non-volatile memory, such as flash memory, PROM, EPROM, EEPROM (e.g., storing firmware 769), DRAM, cache resources, hard disk drives, and/or solid state drives.

The memory 761 may also store localization maps 764 in which the processing resources 710—executing the control instructions 762—continuously compare to sensor data 732 from the various sensor systems 730 of the AV. Execution of the control instructions 762 can cause the processing resources 710 to generate control commands 715 in order to autonomously operate the AV's acceleration 722, braking 724, steering 726, and signaling systems 728 (collectively, the control mechanisms 720). Thus, in executing the control instructions 762, the processing resources 710 can receive sensor data 732 from the sensor systems 730, dynamically compare the sensor data 732 to a current localization map 764, and generate control commands 715 for operative control over the acceleration, steering, and braking of the AV. The processing resources 710 may then transmit the control commands 715 to one or more control interfaces 721 of the control mechanisms 720 to autonomously operate the AV through road traffic on roads and highways, as described throughout the present disclosure.

The memory 761 may also store teleassistance instructions 766 that the processing resources 710 can execute to identify detection or object anomalies, and transmit teleassistance data packages 719 to a backend teleassistance system over the network 780, and receive a teleassistance command 784 in return. Execution of the instructions 762, 764, 766 can cause the processing resources 710 to process the teleassistance commands 784 accordingly to resolve the detected teleassistance state. Thereafter, the processing resources 710 can generate control commands 715 to cause the control mechanisms 720 to autonomously operate the AV along the current route or an alternate route accordingly.

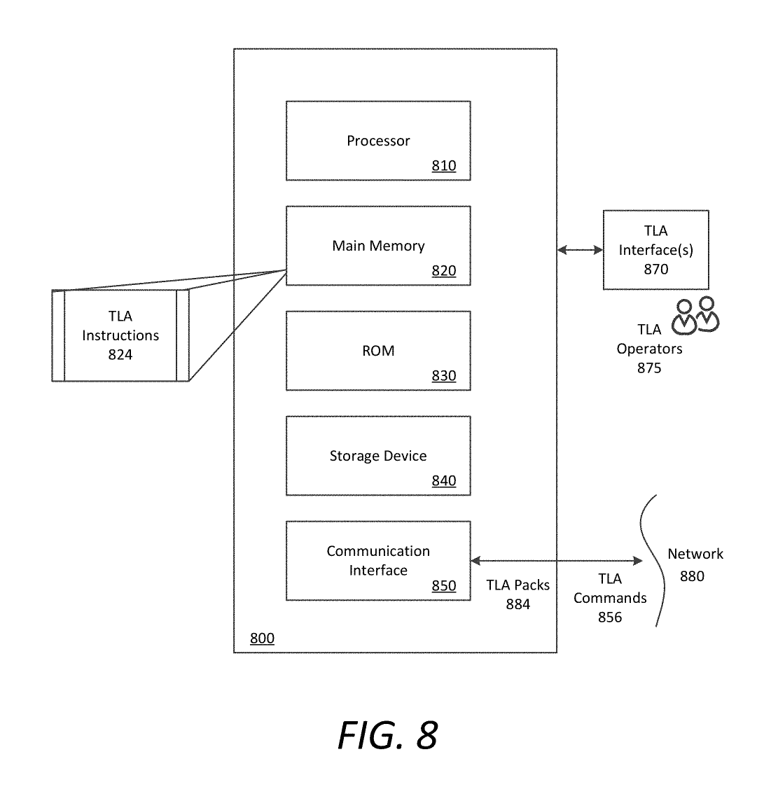

FIG. 8 is a block diagram that illustrates a computer system upon which examples described herein may be implemented. A computer system 800 can be implemented on, for example, a server or combination of servers. For example, the computer system 800 may be implemented as part of a network service for providing transportation services. In the context of FIGS. 1 and 2, the teleassistance system 190, 290 may be implemented using a computer system 800 such as described by FIG. 8.

In one implementation, the computer system 800 includes processing resources 810, a main memory 820, a read-only memory (ROM) 830, a storage device 840, and a communication interface 850. The computer system 800 includes at least one processor 810 for processing information stored in the main memory 820, such as provided by a random access memory (RAM) or other dynamic storage device, for storing information and instructions which are executable by the processor 810. The main memory 820 also may be used for storing temporary variables or other intermediate information during execution of instructions to be executed by the processor 810. The computer system 800 may also include the ROM 830 or other static storage device for storing static information and instructions for the processor 810. A storage device 840, such as a magnetic disk or optical disk, is provided for storing information and instructions.

The communication interface 850 enables the computer system 800 to communicate over one or more networks 880 (e.g., cellular network) through use of the network link (wireless or wired). Using the network link, the computer system 800 can communicate with one or more computing devices, one or more servers, and/or one or more autonomous vehicles. The executable instructions stored in the memory 820 can include teleassistance instructions 824, which enables the computer system 800 to receive teleassistance data packages 884 from AVs operating throughout the given region. In some aspects, execution of the teleassistance instructions 824 can cause the computer system 800 to automatically generate a teleassistance command 856. In addition or as a variation, the computer system 800 can transmit the teleassistance data packages 884 over one or more teleassistance interfaces 870 to human teleassistance operators 875, which can cause the teleassistance commands 856 to be generated and then transmitted back to the AVs in order to resolve teleassistance states or scenarios.

The processor 810 is configured with software and/or other logic to perform one or more processes, steps and other functions described with implementations, such as described with respect to FIGS. 1-6, and elsewhere in the present application. Examples described herein are related to the use of the computer system 800 for implementing the techniques described herein. According to one example, those techniques are performed by the computer system 800 in response to the processor 810 executing one or more sequences of one or more instructions contained in the main memory 820. Such instructions may be read into the main memory 820 from another machine-readable medium, such as the storage device 840. Execution of the sequences of instructions contained in the main memory 820 causes the processor 810 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature. Thus, the absence of describing combinations should not preclude claiming rights to such combinations.

What is claimed is:

1. An autonomous vehicle (AV) comprising:
a sensor suite generating sensor data of a surrounding environment of the AV;
acceleration, braking, and steering systems; and
a control system executing an instruction set that causes that control system to:
dynamically analyze the sensor data to operate the acceleration, braking, and steering systems along a current route;
in analyzing the sensor data, determine a teleassist state requiring remote human assistance;
determine a plurality of decision options to resolve the teleassist state;
generate a teleassistance data package corresponding to the plurality of decision options; and
transmit the teleassistance data package to a remote teleassistance system to enable a human operator to select one of the plurality of decision options.

2. The AV of claim 1, wherein the teleassist state corresponds to at least one of an occlusion, a blockage in the current route, or an indeterminate object.

3. The AV of claim 1, wherein each of the plurality of decision options comprises a manner in which to address the teleassist state, and wherein the executed instruction set causes the control system to determine the plurality of decision options using a combination of map data and the sensor data from the sensor suite.

4. The AV of claim 1, wherein the teleassistance data package comprises telemetry data, a route plan corresponding to the current route, and image data from the sensor suite.

5. The AV of claim 4, wherein the image data comprises a video stream from one or more selected cameras of the sensor suite.

6. The AV of claim 1, wherein the executed instruction set further causes the control system to:
receive a response message from the remote teleassistance system indicating a selected decision option from the plurality of decision options; and
control the acceleration, braking, and steering systems of the AV to execute the selected decision option.

7. The AV of claim 6, wherein the selected decision option corresponds to one of a wait command, an ignore command, a maneuver command, or an alternate route command.

8. The AV of claim 1, wherein the teleassistance data package includes data enabling the human operator to patch into a telemetry stream of the AV and one or more video streams from the sensor suite of AV.

9. The AV of claim 8, wherein the one or more video streams correspond to individual camera systems of the sensor suite, and wherein the teleassistance data package enables the human operator to selectively toggle through video data from each of the individual camera systems.

10. The AV of claim 1, wherein the executed instruction set causes the control system to determine the plurality of decision options by identifying

11. A computer-implemented method of initiating teleassistance, the method being performed by one or more processors of an autonomous vehicle (AV) and comprising:
dynamically analyzing sensor data from a sensor suite of the AV to operate a acceleration, braking, and steering systems of the AV along a current route;
in analyzing the sensor data, determining a teleassist state requiring remote human assistance;
determining a plurality of decision options to resolve the teleassist state;
generating a teleassistance data package corresponding to the plurality of decision options; and
transmitting the teleassistance data package to a remote teleassistance system to enable a human operator to select one of the plurality of decision options.

12. The method of claim 11, wherein the teleassist state corresponds to at least one of an occlusion, a blockage in the current route, or an indeterminate object.

13. The method of claim 11, wherein each of the plurality of decision options comprises a manner in which to address the teleassist state, and wherein the executed instruction set causes the control system to determine the plurality of decision options using a combination of map data and the sensor data from the sensor suite.

14. The method of claim 11, wherein the teleassistance data package comprises telemetry data, a route plan corresponding to the current route, and image data from the sensor suite.

15. The method of claim 14, wherein the image data comprises a video stream from one or more selected cameras of the sensor suite.

16. The method of claim 11, further comprising:
receiving a response message from the remote teleassistance system indicating a selected decision option from the plurality of decision options; and
controlling the acceleration, braking, and steering systems of the AV to execute the selected decision option.

17. The method of claim 16, wherein the selected decision option corresponds to one of a wait command, an ignore command, a maneuver command, or an alternate route command.

18. The method of claim 11, wherein the teleassistance data package includes data enabling the human operator to patch into a telemetry stream of the AV and one or more video streams from the sensor suite of AV.

19. The method of claim 18, wherein the one or more video streams correspond to individual camera systems of the sensor suite, and wherein the teleassistance data package enables the human operator to selectively toggle through video data from each of the individual camera systems.

20. A non-transitory computer readable medium storing instructions that, when executed by one or more processors of an autonomous vehicle (AV), cause the AV to:
dynamically analyze sensor data from a sensor suite of the AV to operate acceleration, braking, and steering systems of the AV along a current route;
in analyzing the sensor data, determine a teleassist state requiring remote human assistance;
determine a plurality of decision options to resolve the teleassist state;
generate a teleassistance data package corresponding to the plurality of decision options; and
transmit the teleassistance data package to a remote teleassistance system to enable a human operator to select one of the plurality of decision options.
